(19) United States
(12) Patent Application Publication
(10) Pub. No.: US 2026/0017031 A1
(43) Pub. Date: Jan. 15, 2026

(54) EXPRESSING WORKFLOWS MULTI-MODALLY: WYSIWYG UI, NATURAL HUMAN TEXT, MACHINE CODED LANGUAGE

(71) Applicant: eBAY iNC., San Jose, CA (US)

(72) Inventors: Piyush Shrivastava, San Jose, CA (US); Shanmukha Sai Vinnakota, Sunnyvale, CA (US); Hari Ransarajan, San Jose, CA (US); Rahul Sharma, Mountain View, CA (US)

(21) Appl. No.: 18/767,019

(22) Filed: Jul. 9, 2024

(51) Int. Cl. G06F 8/34; G06F 8/41

(52) U.S. Cl. CPC G06F 8/34; G06F 8/427

(57) ABSTRACT

An executable in a user-readable format that corresponds to a workflow function is received. The workflow function can be a stepwise process within a workflow. The executable is converted using one of natural language processing or a graph parsing algorithm and then an executable file is accessed. The executable file corresponds to the executable where the workflow function is associated with a task library function created by a machine-level language and stored at the executable file. The executable file is converted using the other of the natural language processing and the graph parsing algorithm. The converted executable file is then linked to a second user interface that is configured to present the workflow function in the user-readable format according to the stepwise process within the workflow.

### TECHNICAL FIELD

Examples of the present disclosure relate generally to systems for generating workflows and, more particularly, but not by way of limitation, to systems for expressing workflows multi-modally.

### BACKGROUND

Typically, when a first user attempts to address a need of a requestor, the first user can implement a workflow that can be used to assist with the implementation of a solution to the need. The workflow can incorporate a number of steps to be followed, such as obtaining information from the requestor, what organization to contact based on the type of need, and how to respond to the requestor if the need can be addressed or if further information is required. In order to generate these workflows, manual intervention is required. A second user must determine what steps need to be taken, what organizations to contact, and what types of responses should be sent to the requestor. Determining the steps to be taken, the organizations to contact, and the response types is time-consuming and introduces many opportunities for error, such as providing incorrect information relating to what organization to contact.

### BRIEF DESCRIPTION OF THE DRAWINGS

Various ones of the appended drawings merely illustrate examples of the present disclosure and should not be considered as limiting its scope.

FIG. 1 is a network diagram illustrating a network environment suitable for receiving workflows at one of a graphical user interface, a human-readable text user interface, or as machine-readable mark-up language and converting the workflows to others of the graphical user interface, the human-readable text user interface, or the machine-readable mark-up language, according to some examples.

FIG. 2 is a system schematic that can be used to generate a workflow, according to some examples.

FIGS. 3 and 4 are user interface diagrams illustrating a workflow user interface, according to some examples.

FIGS. 5 and 6 are user interface diagrams illustrating human-readable text user interfaces that can be used to create a workflow, according to some examples.

FIG. 7 is a user interface diagram illustrating shot prompting techniques that can be used to train a machine learning model, according to some examples.

FIG. 8 is flow chart illustrating a method for providing a workflow input via a system that can receive a workflow at a workflow user interface, via human-readable text, or via a machine-readable mark-up language file, according to some examples.

FIG. 9 is a user interface diagram illustrating a user interface that can be used to create new workflows and access other user interfaces that describe various workflows, according to some examples.

FIG. 10 is a user interface diagram illustrating a workflow user interface that can be used to create a workflow, according to some examples.

FIG. 11 is a user interface diagram illustrating a user interface at which a user can create a workflow using mark-up language, according to some examples.

FIG. 12 is a block diagram illustrating architecture of software used to implement social network-initiated listings, according to some examples.

FIG. 13 is a block diagram illustrating a machine as an example computer system with instructions to cause the machine to implement social network-initiated listings, according to some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Examples relate to a system that can generate a workflow. The system can function to receive a workflow input via a workflow user interface, human-readable text, or a machine-readable mark-up language file. When a workflow input is received at one of the workflow user interface, via human-readable text, or via a machine-readable mark-up language file, the others of the workflow user interface, the human-readable text, and the machine-readable mark-up language file can be automatically generated or updated. Thus, if workflow input is received via human-readable text, a corresponding workflow user interface along with a corresponding mark-up language file can be automatically generated. If the workflow input user interface and the mark-language file already exist, these can be updated based on the workflow input received via human-readable text. Similarly, if workflow input is received via a workflow user interface, corresponding human-readable text along with a corresponding mark-up language file can be automatically generated. Alternatively, if human-readable text and the mark-language file already exist, these can be updated based on the workflow input received at the workflow user interface. Furthermore, if workflow input is received via a machine-readable mark-up language file, a corresponding workflow user interface along with corresponding human-readable text can be automatically generated. If the workflow user interface and the mark-language file already exist, these can be updated based on the workflow input received at the machine-readable mark-up language file.

The workflow can relate to tasks to be taken by a first entity in response to actions by a second entity. The system can provide a first user interface, such as the workflow user interface, that receives the task as an input in a user-readable format. The system can display the task in the user-readable format in a second user interface separate and distinct from the first user interface, such as displaying human-readable text in a second user interface. One of the first and second user interfaces can be a graphical user interface where the input can be provided at graphical elements associated with one of the first and second user interfaces. The graphical elements can be arranged by the first entity in the order of the workflow. The other of the first and second user interfaces can be a user interface landing where the input can be received at the landing as human-readable text such as natural language. The user interface landing can receive and display a workflow as a text string. As used herein, human-readable text can refer to natural language.

The tasks can be executables created and stored as executable files in the machine-readable mark-up language file where functions associated with executing the task can be created or predefined in a machine-level mark-up language such that the task can be task library functions. For inputs received at the workflow user interface, the system can convert the inputs to the machine-level markup language using a graph parsing algorithm. For the user interface landing, the system can convert the human-readable text to the machine-level markup language using a machine learning technique, such as natural language processing. Furthermore, the system can convert the workflows from the machine-level markup language to a graphical output for display on the graphical user interface using the graph parsing algorithm. Simultaneously and/or additionally, the system can convert the workflows from the machine-level markup language to a text string for display at the user interface landing as human-readable text.

To further illustrate, a user can generate a workflow relating to steps to take when a customer representative is contacted by a buyer to discuss an item purchased by the buyer but not received from the seller. The user can access the workflow user interface to create a sequential process by inserting a first step that relates to determining the identity of the seller of the item at a first graphical user interface element. The user can then create a second graphical user interface element that extends from the first graphical user interface element and insert the second step of contacting the seller of the item. A third step can then be created with a graphical user interface element that can be a decision node. The user can insert the question regarding whether or not a response has been received from the seller. If a response has been received from the seller, at a yes branch from the decision node, a fourth step can be created with a graphical user interface element that can relate to having the seller contact the buyer. If a response has not been received from the seller, at a no branch from the decision node, a fifth step can be created with a graphical user interface element that can relate to providing a refund to the buyer.

After the workflow is created at the workflow user interface, a graph parsing algorithm can convert the inputs at each of the graphical user interface elements into mark-up language for creation of a machine-readable mark-up language file. Additionally, a machine learning model can be applied to the created mark-up language file that can convert the machine-readable mark-up language file into human-readable text.

The machine learning model can include a knowledge base having contextual data sets that can be accessed to determine natural language corresponding to mark-up language. The data sets can also be accessed to determine mark-up language corresponding to natural language. Training data can be provided to the machine learning model to train the machine learning model how to correspond mark-up language with natural language and vice versa. The machine learning model can include any type of deep learning algorithm that can perform various natural language processing tasks, such as a large language model. Examples can include Chat Generative Pre-trained Transformer (ChatGPT), Pathways Language Model (PaLM), Large Language Model Meta AI (LLaMA), BigScience Large Open-science Open-access Multilingual Language Model (BLOOM), or the like. Further examples of machine learning models that can be used can include Classification and Regression Training, gradient boosted machines, glmnet, randomForest, SciPy, XGBoost, and various neural networks, such as a Feed-Forward neural network, a radial basis function neural network, a multilayer perceptron neural network, a convolutional neural network, a recurrent neural network, and a modular neural network.

The machine learning model can use deep learning to output text through transformer neural networks. The machine learning model can be provided ground rules and then be provided data, such as previous feedback provided from users. In an unsupervised format, the machine learning model can train to develop an understanding of the relationships objects in the item data having a key: value format and nodes in the hierarchical nodal structure. The machine learning model can include a LLM and more specifically an attention model. The training data can be tagged based on a desired categorization of the first item associated with an input, such as a title for the first item.

Examples address technical problems associated with a system being able to convert inputs received in a first format, such as a natural language format, to a second format, such as a mark-up language format, and a third format, that can include language implemented at a graphical user interface, or as used herein, a user interface, where the second and third formats differ from the first format and from each other. Typically, when data is received in a first format, such as natural language, this data is not readily convertible to a second format, such as a mark-up language format. Moreover, when data is received in the first format, this data is not readily convertible to a third format, such as a language implement by a graphical user interface. This relates to a technical problem in that the system cannot convert among these formats.

Examples provide a technical solution to this technical problem by implementing a system that can readily convert received data in any of these different formats to the other of these formats. The system solves these technical problems with a technical solution that employs a machine learning model to convert the data between the first and second formats and a graph parsing algorithm that can convert the data between the second and third formats.

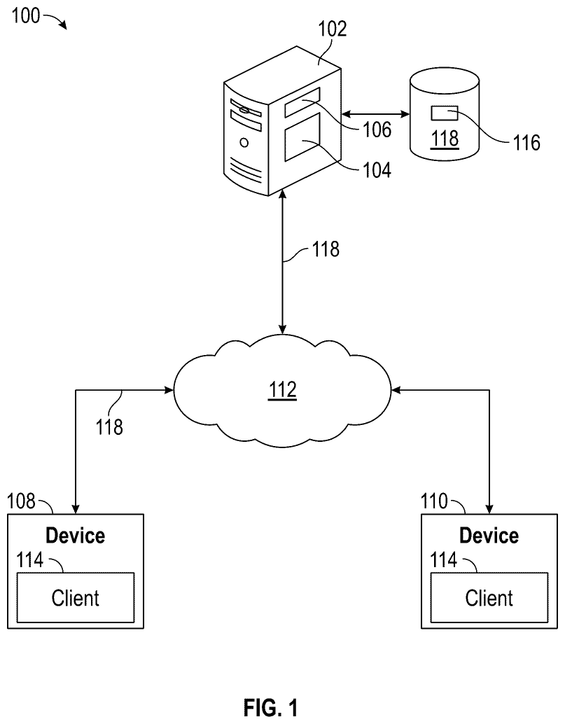

Now turning attention to the Figures, FIG. 1 is a network diagram illustrating a network environment 100 having a server device 102 that can receive workflows using one of a workflow user interface, at a machine-readable mark-up language file, or via human-readable text. The server device 102 can include a machine learning model 104 that can function to convert inputs from a machine-readable mark-up language file to human-readable text. The machine learning model 104 can also function to convert inputs from human-readable text to a machine-readable mark-up language file. The server device 102 can also have a graph parsing algorithm 106 that can function to convert inputs received at a workflow user interface to a machine-readable mark-up language file. The graph parsing algorithm 106 can also function to convert a machine-readable mark-up language file to a workflow user interface.

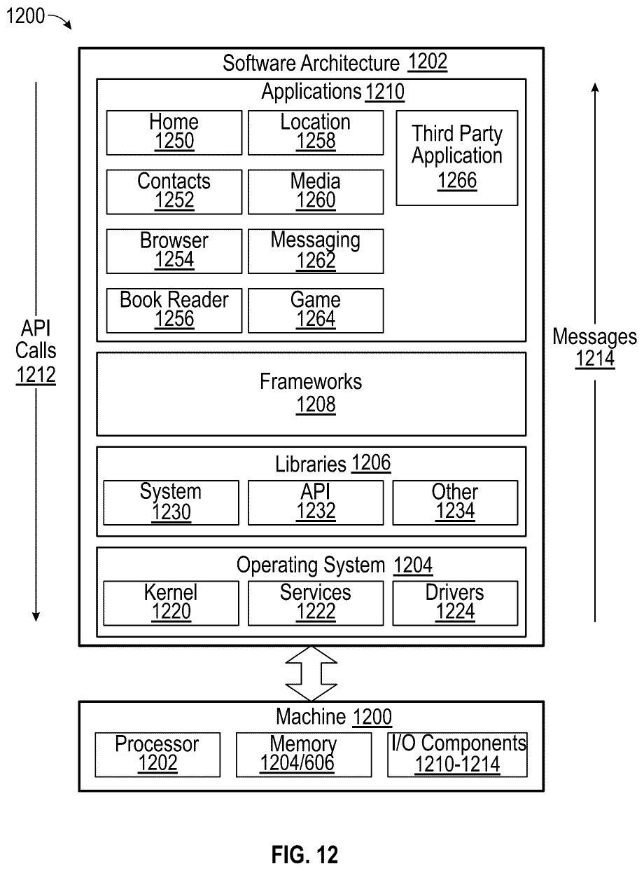

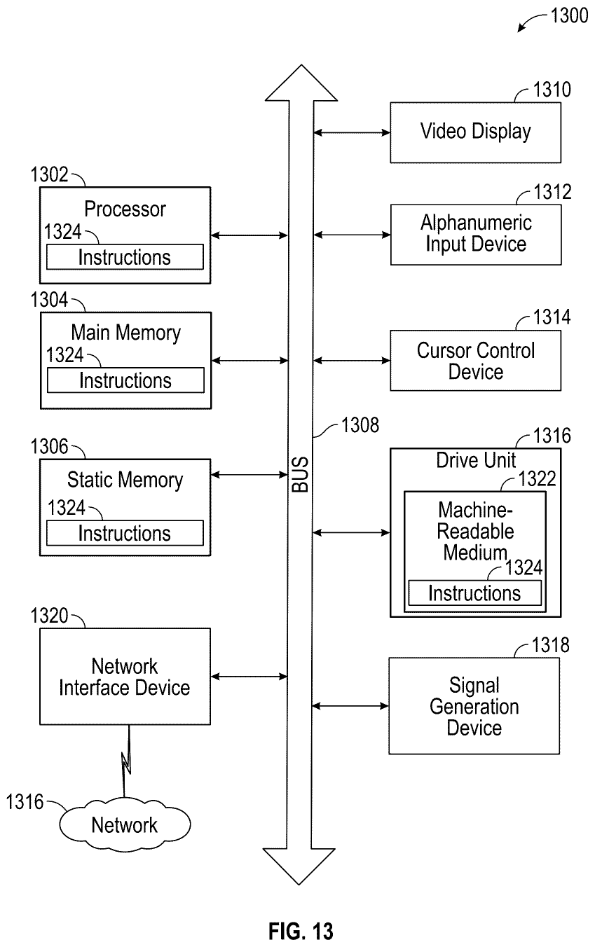

The server device 102 can receive workflow inputs from devices 108 and 110 communicatively coupled to each other and the server device 102 via a network 112. The devices 108 and 110 can interact with the server device 102 using a web client or app client 114. The server 102 and the devices 108 and 110 may each be implemented in a computer system, in whole or in part, as described below with respect to FIGS. 12 and 13.

The devices 108 and 110 can be any computing device suitable for use by a user. For example, the devices 108 and 110 can be a desktop computer, a tablet computer, a portable media device, or a smartphone belonging to a user. The client 114 can be a web browser, which allows for communication between a device, such as the devices 108 and 110, with the server device 102. The client 114 can be an application client that can be a standalone application that can run on one or both of the devices 108 and 110 and communicate with server device 102 to employ the services on the server device 102, such as a Bluetooth™ client application, or the like via a network 112.

The network 112 can be any network that enables communication between or among machines, databases, and devices (e.g., the devices 108 and 110). Accordingly, the network 112 can be a wired network, a wireless network (e.g., a mobile or cellular network), or any suitable combination thereof. The network 112 can include one or more portions that constitute a private network, a public network (e.g., the Internet), or any suitable combination thereof.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIGS. 12 and 13. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

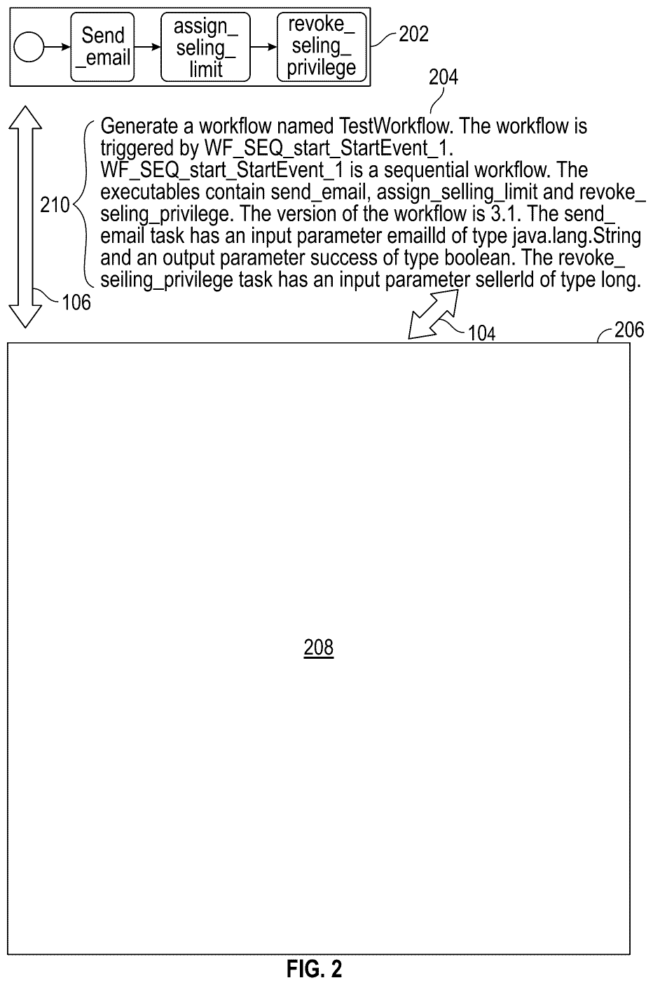

Now making reference to FIG. 2, a system schematic 200 is shown that can be used to generate a workflow. The system schematic 200 can be a paradigm that can express workflows in a workflow user interface domain 202, a human-readable text domain 204, and a machine-readable mark-up language file domain 206. When a change is made via one of a workflow user interface, human-readable text, or mark-up language, the change is propagated to the workflow user interface domain 202, the human-readable text domain 204, and machine-readable mark-up language via the machine-readable mark-up language file domain 206 such that the changes are linked to each of the workflow user interface domain 202, the human-readable text domain 204, and the machine-readable mark-up language file domain 206 via the machine-readable mark-up language file domain 206. When a workflow input is received at one of the workflow user interface domain 202, the human-readable text domain 204, or the machine-readable mark-up language file domain 206, the others of the workflow user interface domain 202, the human-readable text domain 204, and the machine-readable mark-up language file domain 206 can be automatically generated or updated. Thus, if workflow input is received via the human-readable text domain 204, the workflow user interface domain 202 and the machine-readable mark-up language file domain 206 can be automatically generated. If the workflow input user interface domain 202 and the mark-language file domain 206 already exist, these can be updated based on the workflow input received via the human-readable text domain 204. Similarly, if workflow input is received at the workflow user interface domain 202, the human-readable text domain 204 and the machine-readable mark-up language file domain 206 can be automatically generated. Alternatively, if the human-readable text domain 204 and the mark-language file domain 206 already exist, these can be updated based on the workflow input received at the workflow user interface domain 202. Furthermore, if workflow input is received via the machine-readable mark-up language file domain 206, the workflow user interface domain 202 along with the human-readable text domain 204 can be automatically generated. If the workflow user interface domain 202 and the human-readable text domain 204 already exist, these can be updated based on the workflow input received at the machine-readable mark-up language file domain 206. Therefore, when edits to a workflow or a workflow is created in one of the domains 202-206, the edits to the workflow or the created workflow can be automatically propagated to the other of the domains 202-206 such that three-way conversion can occur where the machine-readable mark-up language file domain 206 can facilitate the conversions using the machine learning model 104 and graph parsing algorithm 106.

The workflow user interface domain 202 can include a workflow user interface 300 that a user can be employ to create a graphical representation of a workflow. The workflow user interface 300 can include graphical elements 302-306 for a workflow 308. A user can select one of the graphical elements 302-306 and enter executables 400-404 within the graphical elements 302-306 in the form of text strings. The user can enter the executables 400-404 in the graphical elements 302-306 in a sequential manner such that the graphical elements 302-306 occur one after the other. In addition, the user can enter the executables 400-404 in the graphical elements 302-306 such that ones of the graphical elements 302-306 occur in parallel with other ones of the graphical elements 302-306. The workflow user interface 300 can include selectable elements 308-312, which can correspond to various actions that can be performed within the workflow 308. Furthermore, a user can enter a workflow name 316 that can relate to a name of a workflow being created by a user. In examples where a user has updated an existing workflow, the workflow name 316 can correspond to the name of the workflow being updated. A user can also provide a version number 318, which can correspond to a version of the workflow 308.

The selectable element 310 can be selected when a user desires to provide further executables in the workflow 308. The selectable element 312 can be selected when a user desires to end the workflow 308. The selectable element 324 can be selected when the user desires to add a decision in the workflow 308. The decision can relate to a conditional aspect in the workflow 308. Moreover, the decision can relate to a branch in the workflow.

A conditional aspect can correspond to deciding an aspect of a party with which the workflow 308 is related. To further illustrate, if the workflow 308 is related to an interaction between a buyer and a seller, the conditional aspect can relate to if a party is either a buyer or a seller and the workflow 308 can proceed in one of two manners based on the condition of the party being either a buyer or a seller.

When the decision is a branch in the workflow 308, this can relate to making a decision relating to a type of a party. To further illustrate, a determination can be made if the party is one of a buyer, a seller, or a guest. Depending on whether the party is one of a buyer, a seller, or a guest, the workflow 308 can proceed in different manners. One of the selectable elements 310-314 can also correspond to a repeat operation, where selection of the repeat operation can cause an executable in a graphical element to be repeated.

The executables 400-404 can correspond to pre-defined functions that can be performed in a workflow 308. Examples of executables can include sending a communication to an end user, such as a short messaging service, an email communication, or any other type of electronic communication. Examples can also include suspending an account associated with a user, revoking an account of a user, determining if a response to a communication has been received from a user, or updating an account of a user. However, functions associated with the executables 400-404 are not restricted to the above and can include any type of action that can be implemented with a computing device.

A user can enter text associated with the executables in the graphical elements 302-306 using any type of human-readable format. To further illustrate, a user can enter the text “send_email” at the graphical element 302, the text “assign_selling_limit” at the graphical element 304, and the text “revoke_selling_privilege” at the graphical element 306. These executables can relate to the functions of sending an email, assigning a selling limit to a seller, and revoking the selling privileges of the seller.

When a user enters the executables 400-404 in the graphical elements 302-306, the executables 400-404 can be pushed to the server device 102 where the graph parsing algorithm 106 can provide a syntactio-semantic analysis of the executables 400-404 by mapping the executables 400-404 to a graph-structured representation using any technique, such as Yet Another Markup Language (YAML) or YAML Ain't Markup Language. The graph-structured representation can be associated with predefined modules 116 having predefined instructions in a machine-level markup language. Throughout this document, the term predefined modules 116 can be interchangeable with the term predefined module 116 and vice versa. Thus, any reference to the predefined modules 116 can also correlate to a reference to the predefined module 116 and vice versa. The machine-level markup language can be used to create a task library function, which can be stored as an executable file, such as a mark-up language file.

The predefined module 116 can be created using a human-readable data serialization language that can be used for writing configuration files along with representing structured data and can be stored at a database 118. The predefined module 116 can include the operations to be performed by a computing device to perform the function associated with the executable, such as the executables 400-404. The operations can correlate to workflow functions where the workflow functions can be associated with task library functions that can be created by a machine-level mark-up language. For the executable 400, the predefined module can include code to be implemented by a computing device to send an email to a seller. The code can describe how an action associated with the function should be performed by a computing device, such as sending an email, assigning a limit to a seller, revoking selling privileges of a user, or any other type of action that can be performed with a computing device.

Output of the graph parsing algorithm 106 can be generated at the server device 102, which can then access the predefined modules 116 stored at the database 118. Moreover, the server device 102 can automatically create a machine-readable mark-up language file 208 (FIG. 2) in response to receiving the executables 400-404. The machine-readable mark-up language file 208 can be a YAML file or a Domain-Specific Language (DSL) file. The machine-readable mark-up language file 208 can be at the machine-readable mark-up language file domain 206, a shown with reference to FIG. 2.

The predefined modules 116 can include operations that can be followed by a computing device to achieve the function associated with the executable. The predefined modules 116 can be created and updated by a user at the machine-readable mark-up language file domain 206 via a user interface. In particular, a user can make various inputs at a user interface in order to create and/or update the predefined module 116.

A user can also create a workflow and update existing workflows via the machine-readable mark-up language file domain 206. In particular, a user can input executables for a workflow using a machine-readable mark-up language as described above that can correspond to functions to be executed by a computing device. Furthermore, a user can update existing workflows by updating the machine-readable mark-up language associated with existing workflows. When a user creates a workflow or updates existing workflows, the graph parsing algorithm 106 can convert the machine-readable mark-up language into a graphical structure similar to the workflow 308. In addition, the machine learning model 104 can convert the machine-readable mark-up language file 208 into human-readable text 210 at the human-readable text domain 204.

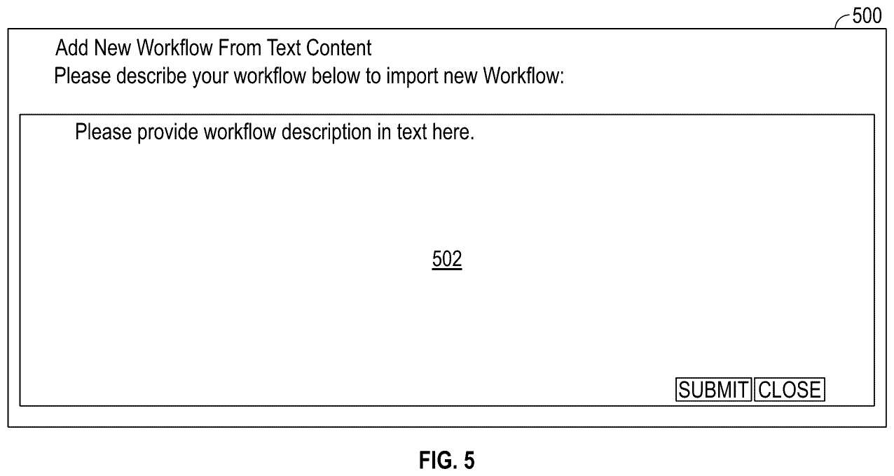

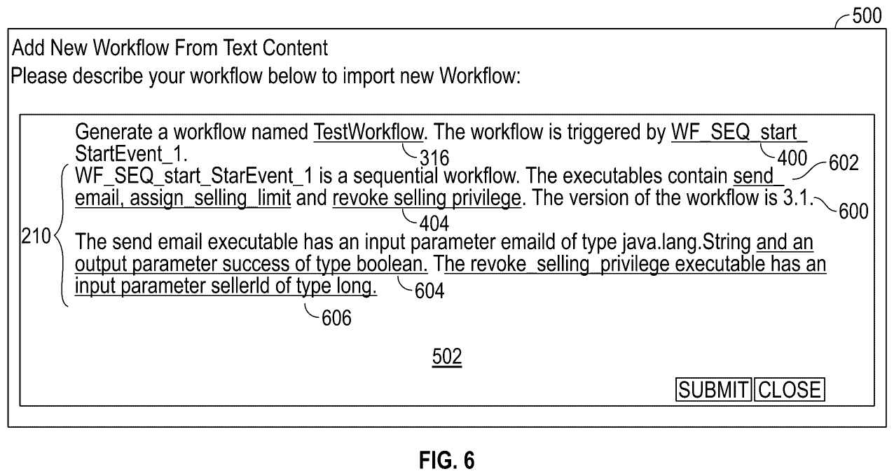

Making reference to FIGS. 5 and 6, a human-readable text user interface 500 can include a landing 502 where a user can input natural language, such as the human-readable text 210, in a regular language sentence in the form of text strings. The human-readable text 210 can include the workflow name 316 along with the executables 400-404 such that the executables 400-404 are in the form of text strings. A user can input a version number 600 that can relate to a version of the workflow 308. The version number 600 can be incremented when updates are made to the workflow 308. Thus, when a user provides the human-readable text 210, the user can enter the workflow version number 600 that is incremented relative to a previous version of the workflow 308. Moreover, when a user is creating a workflow for the first time using human-readable text and the human-readable text user interface 500, the user can indicate that the workflow is the first version.

While the human-readable text 210 can include the executables 400-404 as a text string, a user can provide data 602-606 relating to each of the executables 400-404. For example, a user can provide the data 602 that can provide further clarification regarding the executable 400. In addition, a user can provide the data 604 that can provide clarification for the executable 402 along with the data that can provide further clarification for the executable 404. The human-readable text 210 can also include input relating to whether or not a workflow should be sequential, have parallel steps, or include a decision. Thus, an indication can be received from a user using the human-readable text that a second executable is sequential to the first executable, parallel to the first executable, or is a decision relative to the first executable. As mentioned above, decision can relate to a conditional aspect in a workflow 308 or a branch in a workflow.

As mentioned above, examples provide a paradigm that can express workflows in a workflow user interface domain 202, a human-readable text domain 204, and a machine-readable mark-up language file domain 206. In order to express the workflow 308 between the human-readable text domain 204 and the machine-readable mark-up language file domain 206, the machine learning model 104 can be used. The machine learning model 104 can use deep learning techniques where the machine learning model 104 can break input text into smaller units, such as words in the human-readable text 210 that is provided at the human-readable text user interface landing 502. A neural network, that can include a transformer model, can be used to understand the structure and the meaning of the human-readable text 210. The machine learning model 104 can then predict a token, which can correlate to text within the predefined modules 116, based on previous tokens and patterns the machine learning model 104 observed with training data.

Training data can be provided to the machine learning model 104 to match text in human-readable text with modules in order to identify functions to be performed by a computing device. Furthermore, training data can be provided to the machine learning model 104 to match text in code associated with the modules to natural language text in human-readable text. During a first training phase, the machine learning model 104 can be bilaterally trained. In particular, the machine learning model 104 can be trained to identify modules and the accompanying code based on natural language in human-readable text. During the first training phase, the machine learning model 104 can also be trained to identify natural language for human-readable text based on code in the modules.

After the first training phase, the machine learning model 104 can be used to generate mark-up language and match the machine-readable mark-up language with mark-up language files based on the first training that occurred during the first training phase. At the same time, the machine learning model 104 can be used to generate natural language in human-readable text based on mark-up language in mark-up language files based on the first training. The first training data can also relate to identifying when the human-readable text includes language relating to a workflow having sequential steps and/or parallel steps.

After the passage of a first time period an accuracy of the results generated by the machine learning model 104 can be determined. Accuracy can relate to whether or not the machine learning model 104 correctly matched mark-up language files to human-readable text input at a human-readable text user interface. Accuracy can also relate to whether or not the machine learning model 104 correctly matched natural language in human-readable text to mark-up language files. The accuracy can be compared to a threshold. If the accuracy does not meet the threshold, such as exceeding a threshold when the threshold is associated with an error rate or falling below a threshold when the threshold relates to an accuracy rate, the machine learning model 104 can be bilaterally trained as discussed above during a second training phase.

During the passage of the first time period, observations can be made that the human-readable text includes references to a workflow including a decision, such as workflows including a conditional aspect of a branch in a workflow. During the second training phase, this additional data can be provided to the machine learning model 104 as second training data in order to allow the machine learning model 104 to identify a decision in a workflow that can relate to identifying a conditional aspect or a branch in a workflow.

After the second training phase, the machine learning model 104 can be used to generate mark-up language and match the machine-readable mark-up language with mark-up language files based on the second training that occurred during the second training phase. At the same time, the machine learning model 104 can be used to generate natural language in human-readable text based on mark-up language in mark-up language files. The process of retraining can occur over time. Thus, the machine learning model 104 can change over time.

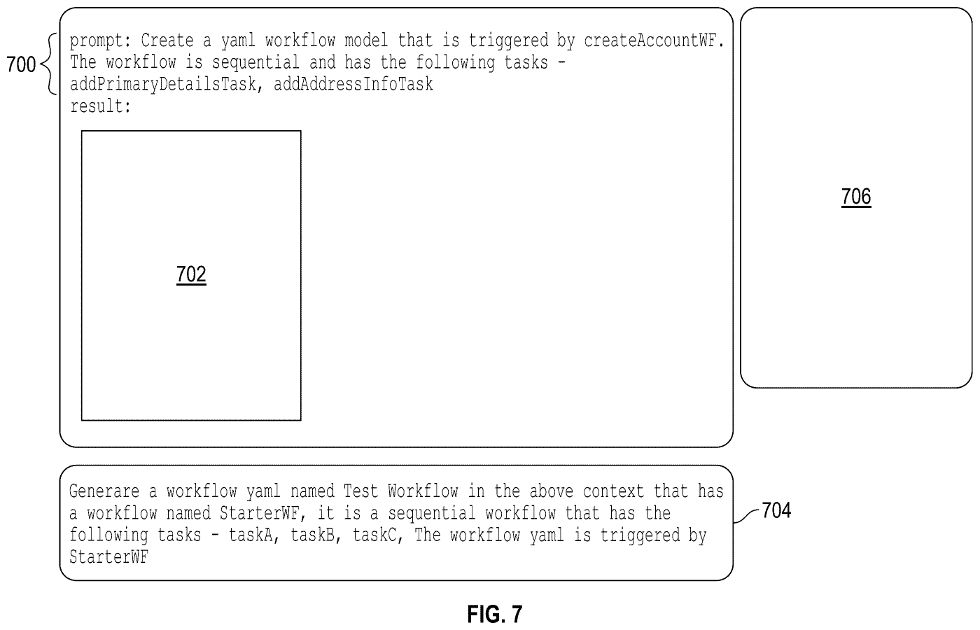

Shot prompting can also be used with transformer-based models to train the machine learning model 104, such as GPT-4 incorporated by LLMs, to guide the LLM's output using a given number of examples or prompts, which can be referred to as shots. Zero, one, or few shot prompting can be used while training the LLM. In one-shot prompting, one example can be given before completing the request. A specialized prompt 700 (FIG. 7) during shot prompting can be provided to the machine learning model 104 along with a result 702, which can be used as training data. The machine learning model 104 can then be provided a prompt 704. With the prompt 704, the machine learning model 104 can return the result 706. Based on the result 706, the machine learning model 104 can be further refined with additional prompts. Thus, the machine learning model 104 can be trained to create a machine-readable mark-up language file using human-readable text. The machine learning model 104 can also be trained to generate human-readable text with a machine-readable mark-up language file using the procedures described herein. Moreover, the LLM can be trained to identify and extract keyₙ: valueₙ pairs from a plurality of first facts.

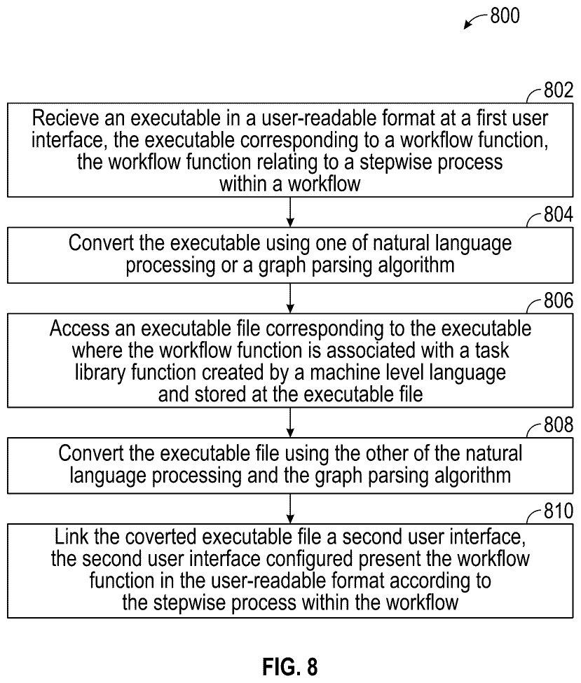

Now making reference to FIG. 8, a method 800 implemented by a computing device, such as the server device 102, for providing a workflow input via a system that can receive the workflow at a workflow user interface, via human-readable text, or via machine-readable mark-up language file is shown. During an operation 802, an executable is received at a first user interface in a user readable format. The executable can correspond to a workflow function that relates to a stepwise process within a workflow. The first user interface can correspond to one of the workflow user interface 300 and the human-readable text user interface 500 where executables, such as the executables 400-404, can be provided. The first user interface can be provided to the device 108 or 110 by the server device 102. Moreover, a user at the device 108/110 can provide the executable at the first user interface. The stepwise process can refer to the sequence in which the executables within the workflow can be performed. As described above, the executables can be performed in a sequential or parallel manner. Moreover, the stepwise functions can include a repeating manner, such as repeating an executable, or in the capacity of a decision, as detailed above with reference to conditional aspects of a workflow or a branch in a workflow.

After receipt of the executable, the method 800 converts the executable using one of natural language processing or a graph parsing algorithm during an operation 804. If the first user interface corresponds to the human-readable text user interface 500, ones of the executables 400-404 can be converted using the machine learning model 104 as detailed above to a machine-readable mark-up language. If the first user interface corresponds to the workflow user interface 300, ones of the executables 400-404 can be converted using the graph parsing algorithm 106 as detailed above to a machine-readable mark-up language. Using the machine-readable mark-up language, during an operation 806, an executable file that can correspond to an executable is accessed. The workflow function can be associated with a task library function as described above. The task library function can be created by a machine-level mark-up language and stored at the executable file, also as described above. During the operation 806, the converted executable can be matched with executable files in order to determine which tasks should be performed by a computing device in order to accomplish the tasks received during the operation 802.

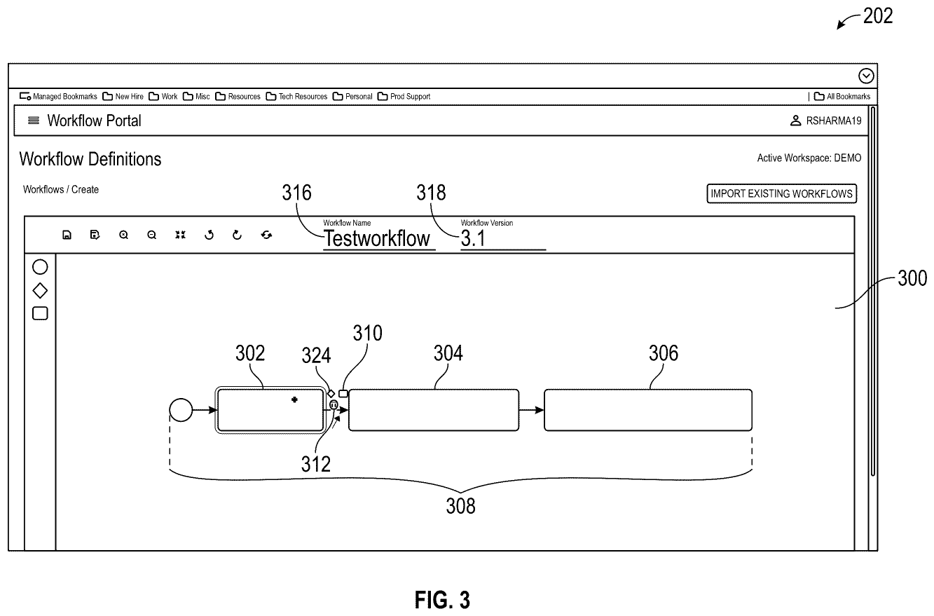

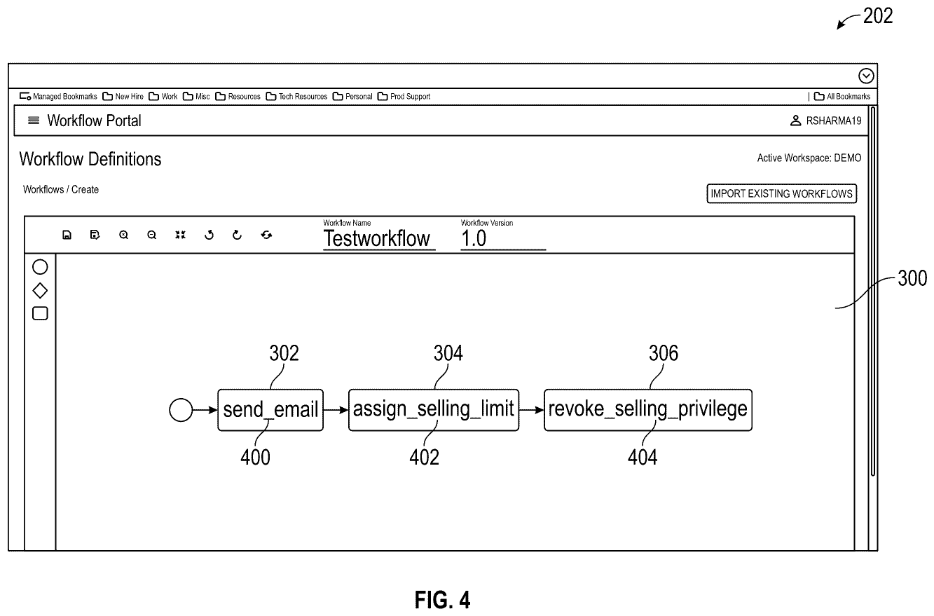

As an example of the method 800 and referred to herein as “the example,” during the operation 802, the server device 102 presents the workflow user interface 300 on the device 108. A user associated with the device 108 creates the graphical elements 302-306 and provides the executables 400-404 at the workflow user interface 300 as discussed with reference to FIGS. 3 and 4. The workflow 308 can include the executables 400-404 in a stepwise manner where the executables are to be performed in a sequential manner, as shown with reference to FIG. 4. During the operation 804, the graph parsing algorithm 106 converts the executables 400-404 to a machine-readable mark-up language as described above. The graph parsing algorithm 106 can then match the executables 400-404 with ones of the predefined modules 116 as detailed above during the operation 806.

Returning to FIG. 8 and the method 800, the executable file is then converted using the other of natural language processing and the graph parsing algorithm during an operation 808. If the first user interface corresponds to the human-readable text user interface 500 and ones of the executables 400-404 were converted using the machine learning model 104, then during the operation 808, the accessed executable file is converted using the graph parsing algorithm 106, as detailed above. If the first user interface corresponds to the workflow user interface 300 and ones of the executables 400-404 were converted using the graph parsing algorithm 106, during the operation 808, the accessed executable file is converted to the human-readable text 210 using the machine learning model 104, as discussed above.

After conversion, the method 800 performs an operation 810, where the converted executable file is linked to a second user interface. The second user interface can be configured to present a workflow in a user-readable format according to the stepwise process within the workflow. Thus, if the workflow was received during the operation 802 at the workflow user interface 300, the executable file can be linked to the human-readable text domain 206 and the human-readable text user interface 500 where the executable file can be at the human-readable text domain 204 and displayed at the landing 502 during the operation 810. The executable file can be stored at the human-readable text domain 204 such that the executable file shows the workflow as the stepwise process. If the workflow was received during the operation 802 at the human-readable text user interface 500, the executable file can be linked to the workflow user interface 300 where the executable file can be at the workflow user interface domain 202 during the operation 810. The executable file can be stored at the workflow user interface domain 202 such that the executable file shows the workflow as the stepwise process.

Turning attention back to the example, the graph parsing algorithm 106 was used to convert the executable during the operation 804. As such, during the operation 808, the machine learning model 104 is used to convert the executables to the human-readable text 210. During the operation 810, the human-readable text is linked to the human-readable text domain 204.

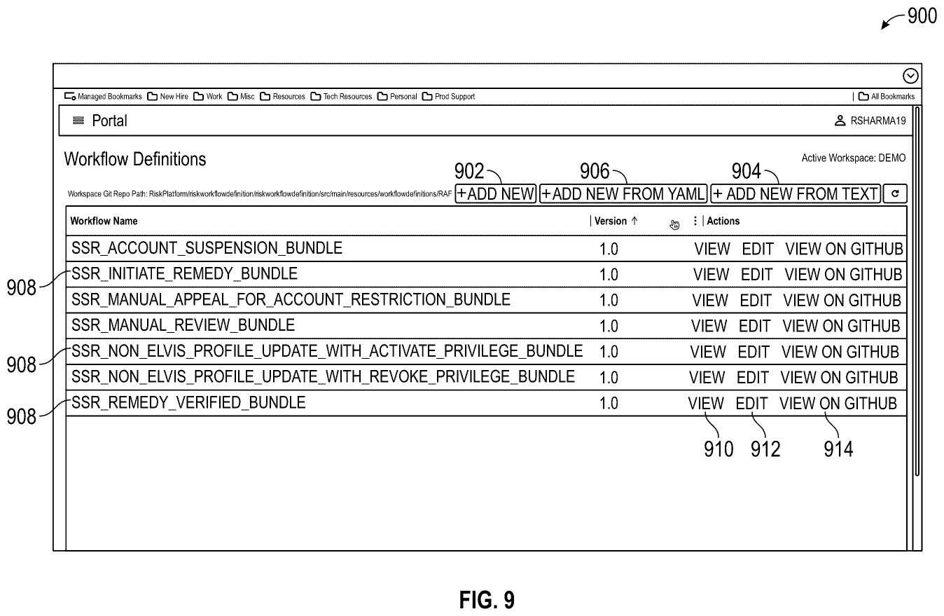

Now making reference to FIG. 9, a user interface 900 is shown that can be used to access other user interfaces that show previously created workflows and create new workflows. The user interface 900 can be displayed on the devices 108 and 110 and can include selectable elements 902-906. If a user desires to create a new workflow, the user can engage one of the selectable elements 902-906.

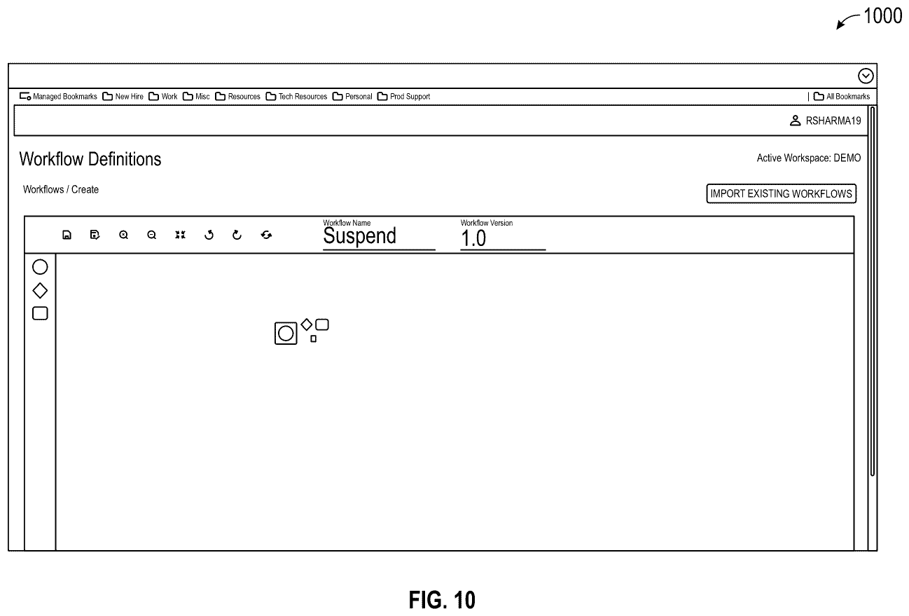

If the user desires to create a workflow with graphical elements using a workflow user interface as described above, the user can engage the selectable element 902. Engagement of the selectable element 902 can cause the display of a workflow user interface 1000, as shown in FIG. 10. At the user interface 1000, a user can create a workflow, such as the workflow 308, that can include the graphical elements 302-306. When the user is done creating a workflow, the user can upload the new workflow to the server device 102, which can create a machine-readable mark-up language file version of the new workflow along with a human-readable text version of the new workflow as described herein.

If a user desires to create a workflow using natural language, such as the human-readable text 210, the selectable element 904 can be engaged. When the selectable element 904 is engaged, the human-readable text user interface 500 is presented. The user can then enter a workflow using natural language at the human-readable text user interface landing 502, as previously described. Furthermore, when the user is done entering a workflow at the human-readable text user interface landing 502, the user can upload the new workflow to the server device 102, which can then create a machine-readable mark-up language file version of the new workflow along with a graphical version of the new workflow as described herein.

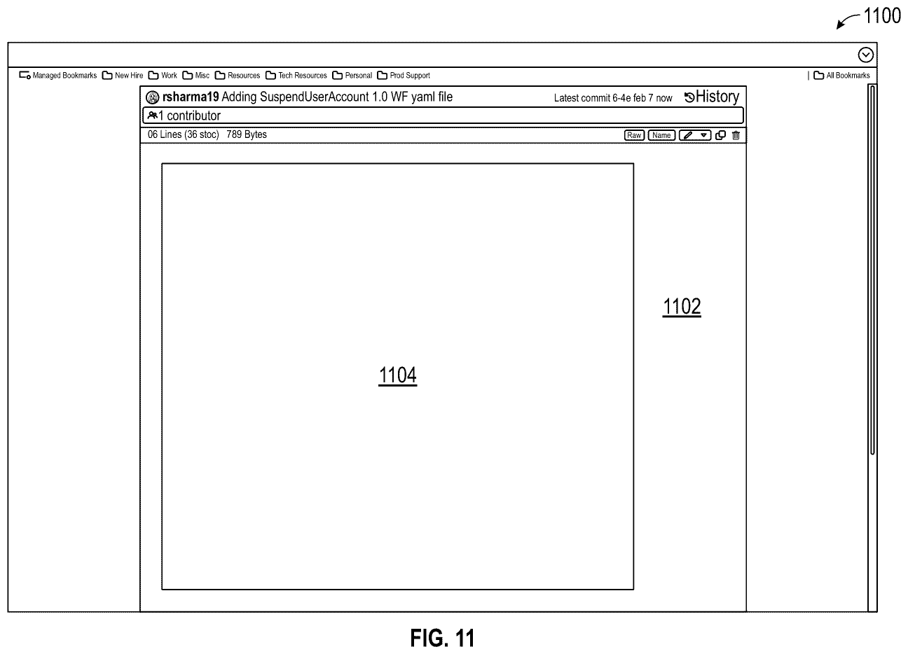

If the user desires to create a new workflow using a machine-readable mark-up language, the user can engage the selectable element 906, which can cause the display of a user interface 1100, as shown in FIG. 11. The user interface 1100 can have a landing 1102 at which the user can enter machine-readable mark-up language 1104 for a new workflow. The machine-readable mark-up language 1104 can include the code a computing device can execute to accomplish functions of a workflow. When the user is done entering a workflow at the landing 1102, the user can upload the new workflow to the server device 102. The server device 102 can then create a human-readable text version of the new workflow along with a graphical version of the new workflow as described herein.

Returning attention to FIG. 9, in addition to creating new workflows, a user can also edit existing workflows 908. In particular, the existing workflows 908 can include selectable elements 910-914. The selectable element 910 can correlate to a workflow user interface domain associated with the particular existing workflow. Thus, if a user desires to edit an existing workflow using a workflow user interface, the user can engage the selectable element 910. Upon engagement of the selectable element 910, an existing workflow user interface, such as the workflow user interface 300 having the executables 400-404 for the workflow 308, can be presented to the user. The user can then edit the workflow 308, such as changing the order of executables, adding executables, deleting executables, and the like. The user can then upload the edited workflow to the server device 102, which can then update a machine-readable mark-up language file version of the existing workflow along with a human-readable text version of the existing workflow as described herein.

The selectable element 912 can correlate to a human-readable text domain associated with the particular existing workflow. If a user desires to edit an existing workflow using natural language, the user can engage the selectable element 912. Upon engagement of the selectable element 912, an existing human-readable text user interface, such as the human-readable text user interface 500 having the executables 400-404 for the workflow 308, can be presented to the user. The user can then edit the workflow 308, such as adding natural language and/or deleting natural language corresponding to an executable along with adding and deleting decisions for the workflow. The user can then upload the edited workflow to the server device 102, which can then update a machine-readable mark-up language file version of the existing workflow along with a graphical version of the existing workflow as described herein.

The selectable element 914 can correspond to a machine-readable mark-up language version associated with an existing workflow. If a user desires to edit an existing workflow using machine-readable mark-up language, the user can engage the selectable element 914. Upon engagement of the selectable element 914, an existing machine-readable mark-up language user interface, such as the user interface 1100 having the executables 400-404 for the workflow 308, can be presented to the user. The user can then edit the workflow 308, such as adding machine-readable mark-up language and/or deleting machine-readable mark-up language corresponding to executables along with adding and/or deleting decisions for the workflow. The user can then upload the edited workflow to the server device 102, which can then update a human-readable text version of the existing workflow along with a graphical version of the existing workflow as described herein.

In further examples, a workflow can be nested in another workflow. In particular, a first workflow can be created as described above at a first time. At a second time, a second workflow can be created. Here, the second workflow can include the first workflow. Thus, the first workflow can be nested within the second workflow. The first workflow can be nested within the second workflow by entering the name of the first workflow in the second workflow as an executable. To further illustrate, the second workflow can correspond to the workflow 308 while the name of the first workflow can correspond to the executable 402. By virtue of entering the name of the first workflow as the executable 402 in the second workflow (the workflow 308), the first workflow can be nested within the second workflow (the workflow 308).

FIG. 12 is a block diagram 1200 illustrating a software architecture 1202, which may be installed on any one or more of the devices described above. FIG. 13 is merely a non-limiting example of a software architecture, and it will be appreciated that many other architectures may be implemented to facilitate the functionality described herein. The software architecture 1202 may be implemented by hardware such as a computer system 1300 of FIG. 13 that includes a processor 1302, memory 1304 and 1306, and I/O components 1310-1314. In this example, the software architecture 1202 may be conceptualized as a stack of layers where each layer may provide a particular functionality. For example, the software architecture 1202 includes layers such as an operating system 1204, libraries 1206, frameworks 1208, and applications 1210. Operationally, the applications 1210 invoke application programming interface (API) calls 1212 through the software stack and receive messages 1214 in response to the API calls 1212, according to some implementations.

In various implementations, the operating system 1204 manages hardware resources and provides common services. The operating system 1204 includes, for example, a kernel 1220, services 1222, and drivers 1224. The kernel 1220 acts as an abstraction layer between the hardware and the other software layers in some implementations. For example, the kernel 1220 provides memory management, processor management (e.g., scheduling), component management, networking, and security settings, among other functionality. The services 1222 may provide other common services for the other software layers. The drivers 1224 may be responsible for controlling or interfacing with the underlying hardware. For instance, the drivers 1224 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1206 provide a low-level common infrastructure that may be utilized by the applications 1210. The libraries 1206 may include system libraries 1230 (e.g., C standard library) that may provide functions such as memory allocation functions, string manipulation functions, mathematic functions, and the like. In addition, the libraries 1206 may include API libraries 1232 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1206 may also include a wide variety of other libraries 1234 to provide many other APIs to the applications 1210.

The frameworks 1208 provide a high-level common infrastructure that may be utilized by the applications 1210, according to some implementations. For example, the frameworks 1208 provide various graphic user interface (GUI) functions, high-level resource management, high-level location services, and so forth. The frameworks 1208 may provide a broad spectrum of other APIs that may be utilized by the applications 1210, some of which may be specific to a particular operating system or platform.

In an example, the applications 1210 include a home application 1250, a contacts application 1252, a browser application 1254, a book reader application 1256, a location application 1258, a media application 1260, a messaging application 1262, a game application 1264, and a broad assortment of other applications such as a third-party application 1266. According to some examples, the applications 1210 are programs that execute functions defined in the programs. Various programming languages may be employed to create one or more of the applications 1210, structured in a variety of manners, such as object-orientated programming languages (e.g., Objective-C, Java, or C++) or procedural programming languages (e.g., C or assembly language). In a specific example, the third-party application 1266 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1266 may invoke the API calls 1212 provided by the mobile operating system (e.g., the operating system 1204) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via the network 112 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 13 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device (cursor control device) 1314 (e.g., a mouse), a disk drive unit 1316, a signal generation device 1318 (e.g., a speaker) and a network interface device 1320.

The drive unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media. Instructions 1324 may also reside within the static memory 1306.

While the machine-readable medium 1322 is shown in an example to be a single medium, the term “machine-readable medium” may include a single medium or multiple media (e.g., a centralized or distributed database, and/or associated caches and servers) that store the one or more instructions or data instructions 1324. The term “machine-readable medium” shall also be taken to include any tangible medium that is capable of storing, encoding or carrying instructions 1324 for execution by the machine and that cause the machine to perform any one or more of the methodologies of the present invention, or that is capable of storing, encoding or carrying data structures utilized by or associated with such instructions 1324. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1324 may further be transmitted or received over the network 112 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1324 for execution by the machine, and includes digital or analog communications signals or other intangible media to facilitate communication of such software.

In various example examples, one or more portions of the network 112 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 112 or a portion of the network 112 may include a wireless or cellular network, and a coupling may be a Code Division Multiple Access (CDMA) connection, a Global System for Mobile communications (GSM) connection, or another type of cellular or wireless coupling. In this example, a coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology. Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” “device-readable medium,” and “machine storage medium,” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense. It will be understood that changes and modifications may be made to the disclosed embodiments without departing from the scope of the present disclosure. These and other changes or modifications are intended to be included within the scope of the present disclosure.

What is claimed is:

1. A method comprising:
receiving, by at least one hardware processor, an executable in a user-readable format at a first user interface, the executable corresponding to a workflow function, the workflow function relating to a stepwise process within a workflow;
converting, by the at least one hardware processor, the executable using one of natural language processing or a graph parsing algorithm;
accessing, by the at least one hardware processor, an executable file corresponding to the executable where the workflow function is associated with a task library function created by a machine-level language and stored at the executable file;
converting, by the at least one hardware processor, the executable file using the other of the natural language processing and the graph parsing algorithm; and
linking, by the at least one hardware processor, the converted executable file to a second user interface, the second user interface configured to present the workflow function in the user-readable format according to the stepwise process within the workflow.

2. The method of claim 1, the method further comprising:
receiving a change to the workflow at the first user interface;
converting the change using one of the natural language processing or the graph parsing algorithm;
changing the executable file with the machine-level language to include the change;
converting the changed executable file using the other of the natural language processing and the graph parsing algorithm; and
linking the converted changed executable file to the second user interface.

3. The method of claim 1, wherein the executable comprises a first executable for a first function of the workflow and the method further comprises receiving a second executable for a second function that occurs after the first function within the workflow.

4. The method of claim 3, wherein the method further comprises receiving an indication that the second executable is sequential to the first executable.

5. The method of claim 3, wherein the method further comprises receiving an indication that the second executable is parallel to the first executable.

6. The method of claim 3, wherein the workflow comprises a first workflow and the second executable relates to a second workflow and receiving the second executable in the first workflow nests the second workflow within the first workflow.

7. The method of claim 1, wherein the first user interface comprises a graphical user interface and the second user interface comprises a user interface landing and the method further comprises:
receiving an indication of a selection of the first user interface;
presenting a graphical element in response to the selection of the first user interface, the graphical element providing an area for receiving the executable;
receiving the executable at the graphical element; and
presenting the executable in the user-readable format at the user interface landing as text strings.

8. The method of claim 1, wherein the first user interface comprises a user interface landing and the second user interface comprises a graphical user interface and the method further comprises:
receiving the executable as text strings;
creating a graphical element; and
presenting the graphical element at the second user interface, wherein the graphical element displays the executable in the user-readable format.

9. The method of claim 1, wherein the task library function corresponds to an action within the stepwise process and being associated with the workflow function.

10. A machine storage medium having instructions embodied thereon, the instructions executable by a processor of a machine to perform operations comprising:
receiving an executable in a user-readable format at a first user interface, the executable corresponding to a workflow function, the workflow function relating to a stepwise process within a workflow;
converting the executable using one of natural language processing or a graph parsing algorithm;
accessing an executable file corresponding to the executable where the workflow function is associated with a task library function created by a machine-level language and stored at the executable file;
converting the executable file using the other of the natural language processing and the graph parsing algorithm; and
linking the converted executable file to a second user interface, the second user interface configured to present the workflow function in the user-readable format according to the stepwise process within the workflow.

11. The non-transitory machine-readable medium of claim 10, the operations further comprising:
receiving a change to the workflow at the first user interface;
converting the change using one of the natural language processing or the graph parsing algorithm;
changing the executable file with the machine-level language to include the change;
converting the changed executable file using the other of the natural language processing and the graph parsing algorithm; and
linking the converted changed executable file to the second user interface.

12. The non-transitory machine-readable medium of claim 10, wherein the executable comprises a first executable for a first function of the workflow and the operations further comprise receiving a second executable for a second function that occurs after the first function within the workflow.

13. The non-transitory machine-readable medium of claim 12, wherein the workflow comprises a first workflow and the second executable relates to a second workflow and receiving the second executable in the first workflow nests the second workflow within the first workflow.

14. The non-transitory machine-readable medium of claim 10, wherein the first user interface comprises a graphical user interface and the second user interface comprises a user interface landing and the operations further comprise:
receiving an indication of a selection of the first user interface;
presenting a graphical element in response to the selection of the first user interface, the graphical element providing an area for receiving the executable;
receiving the executable at the graphical element; and
presenting the executable in the user-readable format at the user interface landing as text strings.

15. The non-transitory machine-readable medium of claim 10, wherein the first user interface comprises a user interface landing and the second user interface comprises a graphical user interface and the operations further comprise:
receiving the executable as text strings;
creating a graphical element; and
presenting the graphical element at the second user interface, wherein the graphical element displays the executable in the user-readable format.

16. A system, comprising:
a processor; and
memory comprising instructions that, when executed by the processor, cause the device to perform operations comprising:
receiving an executable in a user-readable format at a first user interface, the executable corresponding to a workflow function, the workflow function relating to a stepwise process within a workflow;
converting the executable using one of natural language processing or a graph parsing algorithm;
accessing an executable file corresponding to the executable where the workflow function is associated with a task library function created by a machine-level language and stored at the executable file;
converting the executable file using the other of the natural language processing and the graph parsing algorithm; and
linking the converted executable file to a second user interface, the second user interface configured to present the workflow function in the user-readable format according to the stepwise process within the workflow.

17. The system of claim 16, wherein the instructions further cause the device to perform operations comprising:
receiving a change to the workflow at the first user interface;
converting the change using one of the natural language processing or the graph parsing algorithm;
changing the executable file with the machine-level language to include the change;
converting the changed executable file using the other of the natural language processing and the graph parsing algorithm; and
linking the converted changed executable file to the second user interface.

18. The system of claim 17, wherein the workflow comprises a first workflow and the second executable relates to a second workflow and receiving the second executable in the first workflow nests the second workflow within the first workflow.

19. The system of claim 16, wherein the first user interface comprises a graphical user interface and the second user interface comprises a user interface landing and the instructions further cause the device to perform operations including:
receiving an indication of a selection of the first user interface;
presenting a graphical element in response to the selection of the first user interface, the graphical element providing an area for receiving the executable;
receiving the executable at the graphical element; and
presenting the executable in the user-readable format at the user interface landing as text strings.

20. The system of claim 16, wherein the first user interface comprises a user interface landing and the second user interface comprises a graphical user interface and the instructions further cause the device to perform operations including:
receiving the executable as text strings;
creating a graphical element; and
presenting the graphical element at the second user interface, wherein the graphical element displays the executable in the user-readable format.
